(19) United States
(12) Patent Application Publication
(10) Pub. No.: US 2026/0203893 A1
(43) Pub. Date: Jul. 16, 2026

(54) IMAGE PROCESSING METHOD

(71) Applicant: Tencent Technology (Shenzhen) Company Limited, Shenzhen (CN)

(72) Inventor: Binbin GAO, Shenzhen (CN)

(73) Assignee: Tencent Technology (Shenzhen) Company Limited, Shenzhen, GD (CN)

(21) Appl. No.: 19/566,958

(22) Filed: Mar. 13, 2026

Related U.S. Application Data
(63) Continuation of application No. PCT/CN2024/119274, filed on Sep. 18, 2024.

(30) Foreign Application Priority Data
Dec. 8, 2023 (CN) 202311692164.0

(51) Int. Cl. G06T 7/00; G06V 10/26; G06V 10/40; G06V 10/764; G06V 10/774; G06V 10/82

(52) U.S. Cl. CPC G06T 7/001; G06V 10/26; G06V 10/40; G06V 10/764; G06V 10/774; G06V 10/82; G06T 2207/20081; G06T 2207/20084; G06T 2207/20224

(57) ABSTRACT

In an image processing method, an image feature of an image is extracted, and a reconstructed image feature is obtained based on encoding the extracted image feature and decoding the encoded image feature. In the method, first recognition information is obtained, through a discriminator, based on difference information between the extracted image feature and the reconstructed image feature, the first recognition information including first information elements, each one of the first information elements indicating a first probability of a respective pixel of the image having an anomaly. In the method, an anomaly recognition result of the image is determined based on the extracted image feature, the reconstructed image feature, and the first recognition information.

### RELATED APPLICATIONS

The present application is a continuation of International Application No. PCT/CN2024/119274, filed on Sep. 18, 2024, which claims priority to Chinese Patent Application No. 202311692164.0, filed on Dec. 8, 2023, and entitled “IMAGE PROCESSING METHOD AND APPARATUS, DEVICE, STORAGE MEDIUM, AND COMPUTER PROGRAM PRODUCT.” The entire disclosures of the prior applications are hereby incorporated by reference.

### FIELD OF THE TECHNOLOGY

This disclosure relates to the field of artificial intelligence technologies, including an image processing technology.

### BACKGROUND OF THE DISCLOSURE

Image anomaly detection is a technology of detecting whether a pixel in an image having an anomaly or a defect exists in the image. Image anomaly detection may be implemented by using artificial intelligence.

In some applications, a machine learning model may be trained based on a normal image in a manner of unsupervised learning in advance, so that the machine learning model can generate a large reconstruction error on an anomalous image, to implement anomaly detection.

However, in the related art, the machine learning model obtained through training in the manner of unsupervised learning has low accuracy of image anomaly detection.

### SUMMARY

Embodiments of this disclosure provide an image processing method and apparatus, a device, a storage medium, and a computer program product, to improve accuracy of image anomaly detection.

According to an aspect, an image processing method is provided. In the method, an image feature of an image is extracted by processing circuitry. In the method, a reconstructed image feature is obtained based on the extracted image feature through an encoding process followed by a decoding process. In the method, first recognition information is obtained, through a discriminator, based on difference information between the extracted image feature and the reconstructed image feature, the first recognition information including first information elements, each one of the first information elements indicating a first probability of a respective pixel of the image having an anomaly. In the method, an anomaly recognition result of the image is determined by the processing circuitry based on the extracted image feature, the reconstructed image feature, and the first recognition information. The discriminator is a machine learning model obtained through training based on a composite image sample, the composite image sample being an image sample based on inserting an anomaly into an original image sample that has no anomaly.

According to an aspect, an image processing apparatus is provided. The image processing apparatus includes processing circuitry configured to extract an image feature of an image. The processing circuitry is configured to obtain a reconstructed image feature based on the extracted image feature through an encoding process followed by a decoding process. The processing circuitry is configured to obtain, through a discriminator, first recognition information based on difference information between the extracted image feature and the reconstructed image feature, the first recognition information including first information elements, each one of the first information elements indicating a first probability of a respective pixel of the image having an anomaly. The processing circuitry is configured to determine an anomaly recognition result of the image based on the extracted image feature, the reconstructed image feature, and the first recognition information. The discriminator is a machine learning model obtained through training based on a composite image sample, the composite image sample being an image sample based on inserting an anomaly into an original image sample that has no anomaly.

According to an aspect, a non-transitory computer-readable storage medium is provided. The non-transitory computer-readable storage medium stores instructions, which when executed by a processor, cause the processor to perform an image processing method. In the method, an image feature of an image is extracted. In the method, a reconstructed image feature is obtained based on the extracted image feature through an encoding process followed by a decoding process. In the method, first recognition information is obtained, through a discriminator, based on difference information between the extracted image feature and the reconstructed image feature, the first recognition information including first information elements, each one of the first information elements indicating a first probability of a respective pixel of the image having an anomaly. In the method, an anomaly recognition result of the image is determined based on the extracted image feature, the reconstructed image feature, and the first recognition information. The discriminator is a machine learning model obtained through training based on a composite image sample, the composite image sample being an image sample based on inserting an anomaly into an original image sample that has no anomaly.

According to an aspect, an image processing method is provided. In the method, a first image sample having no anomaly is obtained. In the method, first mask information is obtained based on the first image sample, the first mask information indicating a pixel having no anomaly in the first image sample. In the method, a second image sample is obtained, the second image sample being an image sample composited based on the first image sample and second mask information, and the second mask information indicating a pixel that has an anomaly based on modifying a corresponding pixel in the first image sample. In the method, the first image sample is inputted into a feature extractor in an image anomaly detection model, to obtain a first extracted image feature sample outputted by the feature extractor. In the method, the first extracted image feature sample is inputted into an encoder-decoder network in the image anomaly detection model, to obtain a first reconstructed image feature sample outputted by the encoder-decoder network. In the method, first sample difference information between the first reconstructed image feature sample and the first extracted image feature sample is inputted into a discriminator in the image anomaly detection model, to obtain a first recognition information sample outputted by the discriminator. In the method, the second image sample is inputted into the feature extractor, to obtain a second extracted image feature sample outputted by the feature extractor. In the method, the second extracted image feature sample is inputted into the encoder-decoder network, to obtain a second reconstructed image feature sample outputted by the encoder-decoder network. In the method, second sample difference information between the second reconstructed image feature sample and the second extracted image feature sample is inputted into the discriminator, to obtain a second recognition information sample outputted by the discriminator. In the method, a loss function evaluation result is determined, by processing circuitry, based on the first extracted image feature sample, the first reconstructed image feature sample, the first recognition information sample, the second extracted image feature sample, the second reconstructed image feature sample, and the second recognition information sample. In the method, a parameter of the image anomaly detection model is updated, by the processing circuitry, based on the loss function evaluation result. In the method, an anomaly recognition result of a target image is determined through the image anomaly detection model.

According to an aspect, an image processing apparatus is provided. The image processing apparatus includes processing circuitry configured to obtain a first image sample having no anomaly. The processing circuitry is configured to obtain first mask information based on the first image sample, the first mask information indicating a pixel having no anomaly in the first image sample. The processing circuitry is configured to obtain a second image sample, the second image sample being an image sample composited based on the first image sample and second mask information, and the second mask information indicating a pixel that has an anomaly based on modifying a corresponding pixel in the first image sample. The processing circuitry is configured to input the first image sample into a feature extractor in an image anomaly detection model, to obtain a first extracted image feature sample outputted by the feature extractor. The processing circuitry is configured to input the first extracted image feature sample into an encoder-decoder network in the image anomaly detection model, to obtain a first reconstructed image feature sample outputted by the encoder-decoder network. The processing circuitry is configured to input first sample difference information between the first reconstructed image feature sample and the first extracted image feature sample into a discriminator in the image anomaly detection model, to obtain a first recognition information sample outputted by the discriminator. The processing circuitry is configured to input the second image sample into the feature extractor, to obtain a second extracted image feature sample outputted by the feature extractor. The processing circuitry is configured to input the second extracted image feature sample into the encoder-decoder network, to obtain a second reconstructed image feature sample outputted by the encoder-decoder network. The processing circuitry is configured to input second sample difference information between the second reconstructed image feature sample and the second extracted image feature sample into the discriminator, to obtain a second recognition information sample outputted by the discriminator. The processing circuitry is configured to determine a loss function evaluation result based on the first extracted image feature sample, the first reconstructed image feature sample, the first recognition information sample, the second extracted image feature sample, the second reconstructed image feature sample, and the second recognition information sample. The processing circuitry is configured to update a parameter of the image anomaly detection model based on the loss function evaluation result. The processing circuitry is configured to determine an anomaly recognition result of a target image through the image anomaly detection model.

According to an aspect, a non-transitory computer-readable storage medium is provided. The non-transitory computer-readable storage medium stores instructions, which when executed by a processor, cause the processor to perform an image processing method. In the method, first mask information is obtained based on the first image sample, the first mask information indicating a pixel having no anomaly in the first image sample. In the method, a second image sample is obtained, the second image sample being an image sample composited based on the first image sample and second mask information, and the second mask information indicating a pixel that has an anomaly based on modifying a corresponding pixel in the first image sample. In the method, the first image sample is inputted into a feature extractor in an image anomaly detection model, to obtain a first extracted image feature sample outputted by the feature extractor. In the method, the first extracted image feature sample is inputted into an encoder-decoder network in the image anomaly detection model, to obtain a first reconstructed image feature sample outputted by the encoder-decoder network. In the method, first sample difference information between the first reconstructed image feature sample and the first extracted image feature sample is inputted into a discriminator in the image anomaly detection model, to obtain a first recognition information sample outputted by the discriminator. In the method, the second image sample is inputted into the feature extractor, to obtain a second extracted image feature sample outputted by the feature extractor. In the method, the second extracted image feature sample is inputted into the encoder-decoder network, to obtain a second reconstructed image feature sample outputted by the encoder-decoder network. In the method, second sample difference information between the second reconstructed image feature sample and the second extracted image feature sample is inputted into the discriminator, to obtain a second recognition information sample outputted by the discriminator. In the method, a loss function evaluation result is determined based on the first extracted image feature sample, the first reconstructed image feature sample, the first recognition information sample, the second extracted image feature sample, the second reconstructed image feature sample, and the second recognition information sample. In the method, a parameter of the image anomaly detection model is updated based on the loss function evaluation result. In the method, an anomaly recognition result of a target image is determined through the image anomaly detection model.

According to an aspect, an image processing method is provided, performed by a computer device, the method including: performing feature extraction on an image, to obtain an extracted image feature of the image; encoding and decoding the extracted image feature, to obtain a reconstructed image feature; inputting difference information between the extracted image feature and the reconstructed image feature into a discriminator, to obtain first recognition information outputted by the discriminator, the first recognition information including a first information element corresponding to each pixel of the image, and the first information element indicating a probability that the corresponding pixel has an anomaly; and the discriminator being a machine learning model obtained through training based on a composite image sample, and the composite image sample being an image sample that has an anomaly and that is composited based on an image sample having no anomaly; and determining an anomaly recognition result of the image based on the extracted image feature, the reconstructed image feature, and the first recognition information.

According to an aspect, an image processing method is provided, the method including: obtaining first mask information and a second image sample based on a first image sample, the first mask information being configured for indicating a pixel having no anomaly in the first image sample, the second image sample being an image sample composited based on the first image sample and second mask information, and the second mask information being configured for indicating a pixel that has an anomaly and that is to be added to the first image sample; inputting the first image sample into a feature extractor in an image anomaly detection model, to obtain a first extracted image feature sample outputted by the feature extractor; inputting the first extracted image feature sample into an encoder-decoder network in the image anomaly detection model, to obtain a first reconstructed image feature sample outputted by the encoder-decoder network; and inputting difference information between the first reconstructed image feature sample and the first extracted image feature sample into a discriminator in the image anomaly detection model, to obtain a first recognition information sample outputted by the discriminator; inputting the second image sample into the feature extractor, to obtain a second extracted image feature sample outputted by the feature extractor; inputting the second extracted image feature sample into the encoder-decoder network, to obtain a second reconstructed image feature sample outputted by the encoder-decoder network; and inputting difference information between the second reconstructed image feature sample and the second extracted image feature sample into the discriminator, to obtain a second recognition information sample outputted by the discriminator; determining a loss function value based on the first extracted image feature sample, the first reconstructed image feature sample, the first recognition information sample, the second extracted image feature sample, the second reconstructed image feature sample, and the second recognition information sample; and updating a parameter of the image anomaly detection model by using the loss function value, the image anomaly detection model being configured to implement the image processing method according to the foregoing first aspect.

According to another aspect, an image processing apparatus is provided, the apparatus including: a feature extraction module, configured to perform feature extraction on an image, to obtain an extracted image feature of the image; an encoder-decoder network module, configured to encode and decode the extracted image feature, to obtain a reconstructed image feature; a reconstruction module, configured to input difference information between the extracted image feature and the reconstructed image feature into a discriminator, to obtain first recognition information outputted by the discriminator, the first recognition information including a first information element corresponding to each pixel of the image, and the first information element being configured for indicating a probability that the corresponding pixel has an anomaly; and the discriminator being a machine learning model obtained through training based on a composite image sample, and the composite image sample being an image sample that has an anomaly and that is composited based on an image sample having no anomaly; and a recognition module, configured to determine an anomaly recognition result of the image based on the extracted image feature, the reconstructed image feature, and the first recognition information.

According to another aspect, an image processing apparatus is provided, the apparatus including: a sample processing module, configured to obtain first mask information and a second image sample based on a first image sample, the first mask information being configured for indicating a pixel having no anomaly in the first image sample, the second image sample being an image sample composited based on the first image sample and second mask information, and the second mask information being configured for indicating a pixel that has an anomaly and that is to be added to the first image sample; a model processing module, configured to input the first image sample into a feature extractor in an image anomaly detection model, to obtain a first extracted image feature sample outputted by the feature extractor; input the first extracted image feature sample into an encoder-decoder network in the image anomaly detection model, to obtain a first reconstructed image feature sample outputted by the encoder-decoder network; input difference information between the first reconstructed image feature sample and the first extracted image feature sample into a discriminator in the image anomaly detection model, to obtain a first recognition information sample outputted by the discriminator; input the second image sample into the feature extractor, to obtain a second extracted image feature sample outputted by the feature extractor; input the second extracted image feature sample into the encoder-decoder network, to obtain a second reconstructed image feature sample outputted by the encoder-decoder network; and input difference information between the second reconstructed image feature sample and the second extracted image feature sample into the discriminator, to obtain a second recognition information sample outputted by the discriminator; a loss obtaining module, configured to determine a loss function value based on the first extracted image feature sample, the first reconstructed image feature sample, the first recognition information sample, the second extracted image feature sample, the second reconstructed image feature sample, and the second recognition information sample; and a parameter update module, configured to update a parameter of the image anomaly detection model by using the loss function value, the image anomaly detection model being configured to implement the image processing method according to the foregoing first aspect.

According to another aspect, a computer device is provided, the computer device including processing circuitry (e.g., a processor) and a memory (e.g., including a non-transitory computer-readable storage medium), the memory having at least one instruction, at least one program, a code set, or an instruction set stored therein, and the at least one instruction, the at least one program, the code set, or the instruction set being loaded and executed by the processor to implement the image processing method according to the foregoing embodiments of this disclosure.

According to another aspect, a non-transitory computer-readable storage medium is provided, the non-transitory storage medium having at least one instruction, at least one program, a code set, or an instruction set stored therein, and the at least one instruction, the at least one program, the code set, or the instruction set being loaded and executed by processing circuitry (e.g., a processor) to implement the image processing method according to the foregoing embodiments of this disclosure.

According to another aspect, a computer program product or a computer program is provided, the computer program product or the computer program including computer instructions, and the computer instructions being stored in a non-transitory computer-readable storage medium. Processing circuitry (e.g., a processor) of a computer device reads the computer instructions from the non-transitory computer-readable storage medium, and the processor executes the computer instructions, so that the computer device performs the image processing method according to the foregoing embodiments.

The technical solution provided in one or more embodiments of this disclosure has at least the following beneficial effects.

In one or more embodiments of this disclosure, after the extracted image feature is extracted from the image, feature reconstruction is performed on the extracted image feature in an encoding and decoding manner, to obtain the reconstructed image feature. Further, anomaly discrimination is performed through the discriminator based on the difference information between the reconstructed image feature and the extracted image feature, to obtain the first recognition information indicating the probability that each pixel of the image has an anomaly. Finally, the anomaly recognition result of the image is comprehensively obtained with reference to the image features before and after reconstruction and the first recognition information. In the foregoing solution, in addition to recognizing anomaly conditions of the pixels in the image by using the image features before and after reconstruction, the anomaly conditions of the pixels in the image are further determined through the discriminator based on the difference information between the image features before and after reconstruction. In this way, the anomaly conditions of the pixels in the image are comprehensively determined with reference to the image features before and after reconstruction and a discrimination result determined based on the difference information between the image features before and after reconstruction, so that pixel-level image anomaly detection can be implemented while ensuring accuracy of image anomaly detection. In addition, the discriminator is obtained through training based on the composite image sample that is composited based on a normal image sample. Therefore, an anomalous image does not need to be collected and labeled manually in a training process of the discriminator, and training may be performed in a manner of unsupervised learning, so that a quantity of samples that can be used during training of the discriminator can be increased, an effect of training the discriminator by using the composite image sample is improved, and a difference from an effect of training the discriminator by using a real anomalous image is reduced, to ensure accuracy of the discriminator, thereby ensuring accuracy of anomaly detection performed on the pixels of the image through the discriminator.

### BRIEF DESCRIPTION OF THE DRAWINGS

To describe technical solutions of embodiments of this disclosure, the following briefly introduces the accompanying drawings for describing one or more embodiments of this disclosure. The accompanying drawings in the following descriptions show only some aspects of this disclosure.

FIG. 1 is a diagram of system composition of an image processing system according to this disclosure.

FIG. 2 is a schematic flowchart of an image processing method according to an embodiment.

FIG. 3 is a schematic flowchart of an image processing method according to an embodiment.

FIG. 4 is a schematic flowchart of an image processing method according to an embodiment.

FIG. 5 is a schematic flowchart of an image processing method according to an embodiment.

FIG. 6 is a diagram of an architecture of an unsupervised+discriminative reconstruction network according to this disclosure.

FIG. 7 is a comparison diagram of a test result according to this disclosure.

FIG. 8 is a schematic diagram of an anomaly recognition comparison according to this disclosure.

FIG. 9 is a block diagram of a structure of an image processing apparatus according to an embodiment of this disclosure.

FIG. 10 is a block diagram of a structure of an image processing apparatus according to an embodiment of this disclosure.

FIG. 11 is a schematic diagram of a structure of a server according to an embodiment of this disclosure.

### DESCRIPTION OF EMBODIMENTS

Embodiments are described herein, and examples thereof are shown in the accompanying drawings. When the following descriptions are made with reference to the accompanying drawings, unless otherwise indicated, the same numbers in different accompanying drawings represent the same or similar elements. The implementations described in the following embodiments do not represent all implementations consistent with this disclosure. The described implementations are merely non-limiting examples consistent with some aspects of this disclosure. Other embodiments are within the scope of this disclosure.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

FIG. 1 is a diagram of system composition of an image processing system according to embodiments of this disclosure. As shown in FIG. 1, the system includes an image acquisition device 120, a terminal 140, and a server 160. In some embodiments, the system may further include a database 180.

The image acquisition device 120 may be a device configured to acquire an image. The image acquisition device 120 may have a built-in or external camera component.

The image acquisition device 120 may include an image output interface, for example, a universal serial bus (USB) interface, a high definition multimedia interface (HDMI) interface, or an Ethernet interface. Alternatively, the image output interface may be a wireless interface, for example, a wireless local area network (WLAN) interface or a Bluetooth interface.

Accordingly, based on different types of the image output interface, the image may be exported in a plurality of manners. For example, the image may be exported to the terminal 140 in a wired or a short-distance wireless manner, or the image may be exported to the terminal 140 or the server 160 via a local area network or the Internet.

The terminal 140 may be a terminal device having a processing capacity and an interface displaying function. For example, the terminal 140 may be a mobile phone, a tablet computer, an e-book reader, smart glasses, a laptop portable computer, a desktop computer, or the like.

The terminal 140 may be a terminal used by a user, or may be a terminal used by a developer.

When the terminal 140 is a terminal used by a developer, the developer may develop, through the terminal 140, a machine learning model configured for image processing, and deploy the machine learning model to the server 160 or the terminal used by the user.

When the terminal 140 is a terminal used by a user, an application that obtains an image, performs anomaly recognition on the image, and presents a recognition result may be installed in the terminal 140. The application may have a built-in machine learning model or invoke the foregoing machine learning model configured for image processing. After obtaining the image acquired by the image acquisition device 120, the terminal 140 may obtain an image by using the application, perform anomaly recognition on the image, obtain a corresponding anomaly recognition result, and present the anomaly recognition result for reference by the user.

In the system shown in FIG. 1, the terminal 140 and the image acquisition device 120 are physical devices physically separated. In some embodiments, in another possible implementation, when the terminal 140 is a terminal used by a user, the terminal 140 and the image acquisition device 120 may be integrated into a single physical device. For example, the terminal 140 may be a smartphone with a built-in camera.

The server 160 may be an independent physical server, or may be a server cluster or a distributed system that includes a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

The server 160 may be a server that provides a background service for the application installed in the terminal 140. The background server may be configured to manage versions of the application, perform background processing on the image obtained by the application and return a processing result, perform background training on the machine learning model developed by the developer, and the like.

The database 180 may be a Redis database, or may be a database of another type. The database 180 is configured to store various types of data.

In some embodiments, the terminal 140 may be connected to the server 160 via a communication network. In some embodiments, the image acquisition device 120 may also be connected to the server 160 via a communication network. In some embodiments, the communication network is a wired network or wireless network.

In some embodiments, the system may further include a management device (not shown in FIG. 1). The management device is connected to the server 160 via a communication network. In some embodiments, the communication network is a wired network or wireless network.

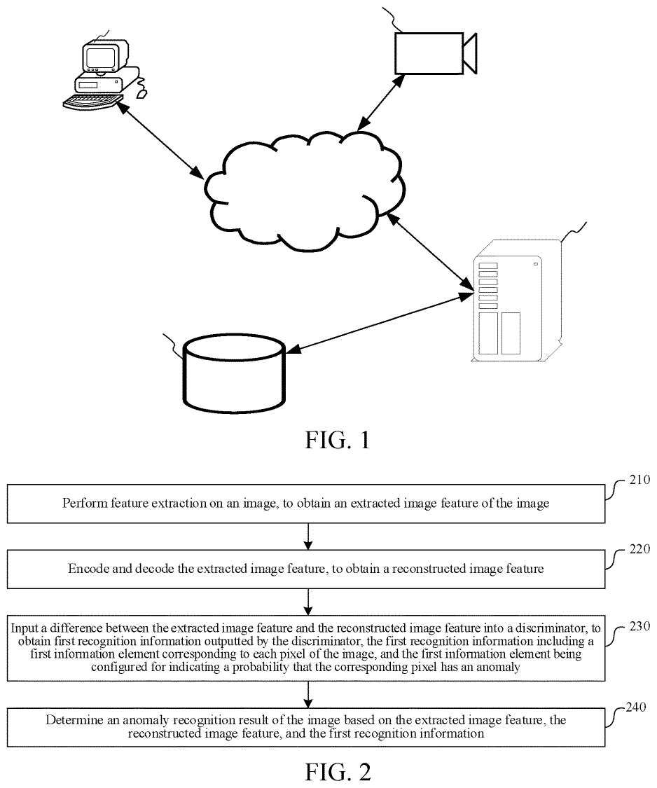

FIG. 2 is a schematic flowchart of an image processing method according to an embodiment. The method may be performed by a computer device. For example, the computer device may be a server, or the computer device may be a terminal, or the computer device may include a server and a terminal. The server may be the server 160 in the embodiment as shown in FIG. 1, and the terminal may be the terminal 140 used by the user in the embodiment as shown in FIG. 1. The computer device may be implemented as a model application device configured to perform image anomaly recognition. As shown in FIG. 2, the image processing method may include the following operations.

Operation 210: Perform feature extraction on an image, to obtain an extracted image feature of the image. For example, an image feature of an image is extracted by processing circuitry.

In at least one embodiment of this disclosure, the computer device may perform processing such as convolution and pooling on the image, to extract the extracted image feature from the image.

The computer device, when performing feature extraction on the image, may extract a plurality of image features of different scales (that is, a quantity of feature dimensions), and fuse the plurality of image features of different scales, to obtain the extracted image feature.

For example, the computer device may perform multi-level feature extraction on the image. When performing feature extraction at a first level, the computer device performs an operation such as convolution on the input image, to obtain an image feature at the first level. When performing feature extraction at a subsequent level, the computer device performs an operation such as convolution on image features at one or more previous levels, to obtain an image feature at the subsequent level. A dimension of the image feature of the previous level may be greater than or equal to a dimension of the image feature at the subsequent level.

In some embodiments, if the dimension of the image feature at the previous level is greater than the dimension of the image feature at the subsequent level, the computer device, when fusing the plurality of image features of different scales, may first unify the dimensions of the image features of the plurality of levels, for example, unify the dimensions into a dimension of an image feature at a last level, to obtain a plurality of image features of the same dimension, and then concatenate the plurality of image features of the same dimension, to obtain the extracted image feature.

In some embodiments, the computer device, when fusing the plurality of image features of the same dimension, may alternatively perform averaging or weighted averaging on a feature of each dimension in the plurality of image features of the same dimension, to obtain the extracted image feature.

Operation 220: Encode and decode the extracted image feature, to obtain a reconstructed image feature. For example, a reconstructed image feature is obtained based on the extracted image feature through an encoding process followed by a decoding process.

In at least one embodiment of this disclosure, the process of encoding and decoding the extracted image feature may be a process of performing crossing and reconstruction on features of all dimensions in the extracted image feature.

For example, the computer device may perform multi-level processing on features of all dimensions in the extracted image feature. In processing at each level, the computer device performs processing based on an attention mechanism such as weighting, convolution, and pooling on an image feature, and outputs an image feature obtained through processing to a next level, to finally obtain the reconstructed image feature.

Operation 230: Input difference information between the extracted image feature and the reconstructed image feature into a discriminator, to obtain first recognition information outputted by the discriminator, the first recognition information including a first information element corresponding to each pixel of the image, and the first information element being configured for indicating a probability that the corresponding pixel has an anomaly. For example, first recognition information is obtained by the processing circuitry, through a discriminator, based on difference information between the extracted image feature and the reconstructed image feature. In some embodiments, the first recognition information includes first information elements, each one of the first information elements indicating a first probability of a respective pixel of the image having an anomaly.

The discriminator is a machine learning model obtained through training based on a composite image sample, and the composite image sample is an image sample that has an anomaly and that is composited based on an image sample having no anomaly. For example, the composite image sample is generated based on inserting an anomaly into an original image sample that has no anomaly.

In at least one embodiment of this disclosure, an image having an anomaly may be composited in advance by using an image having no anomaly, and then one discriminator is obtained through training based on the image having an anomaly. An input of the discriminator is the difference information between the reconstructed image feature and the extracted image feature, and an output of the discriminator is information configured for indicating a probability that each pixel of the image has an anomaly.

For example, the image in operation 210 may include H×W pixels, the first recognition information includes H×W first information elements, and the H×W first information elements are in one-to-one correspondence with the H×W pixels.

The first information element may be a probability value, and the probability value indicates the probability that the corresponding pixel has an anomaly. Alternatively, the first information element may be an anomaly score, and the anomaly score may be positively correlated or negatively correlated to the probability that the corresponding pixel has an anomaly.

For example, the first information element is an anomaly score. The first recognition information may be shown in the following Table 1.

TABLE 1

| | | | | | | | | | |
|---|---|---|---|---|---|---|---|---|---|
| 1 | 3 | 2 | 1 | 4 | 1 | 0 | 1 | . . . | 0 |
| 1 | 1 | 2 | 1 | 2 | 0 | 1 | 2 | . . . | 1 |
| 0 | 2 | 1 | 4 | 70 | 2 | 2 | 2 | . . . | 1 |
| 0 | 1 | 0 | 85 | 92 | 88 | 1 | 0 | . . . | 0 |
| 0 | 3 | 1 | 1 | 81 | 3 | 0 | 1 | . . . | 3 |
| 1 | 4 | 0 | 2 | 1 | 1 | 3 | 3 | . . . | 3 |
| . . . | . . . | . . . | . . . | . . . | . . . | . . . | . . . | . . . | . . . |
| 2 | 2 | 2 | 1 | 1 | 0 | 1 | 1 | . . . | 2 |

As shown in Table 1, each blank space represents one first information element, each first information element is represented as an anomaly score, and a value range of the anomaly score is [0, 100]. A higher anomaly score indicates a higher probability that a corresponding pixel has an anomaly.

Operation 240: Determine an anomaly recognition result of the image based on the extracted image feature, the reconstructed image feature, and the first recognition information.

In at least one embodiment of this disclosure, the computer device may determine a probability that each pixel of the image has an anomaly based on difference information between the extracted image feature and the reconstructed image feature, and then comprehensively obtain the anomaly recognition result of the image with reference to the first recognition information.

Therefore, in one or more embodiments of this disclosure, after the extracted image feature is extracted from the image, feature reconstruction is performed on the extracted image feature in an encoding and decoding manner, to obtain the reconstructed image feature. Further, anomaly discrimination is performed through the discriminator based on the difference information between the reconstructed image feature and the extracted image feature, to obtain the first recognition information indicating the probability that each pixel of the image has an anomaly. Finally, the anomaly recognition result of the image is comprehensively obtained with reference to the image features before and after reconstruction and the first recognition information. In the foregoing solution, in addition to recognizing anomaly conditions of the pixels in the image by using the image features before and after reconstruction, the anomaly conditions of the pixels in the image are further determined through the discriminator based on the difference information between the image features before and after reconstruction. In this way, the anomaly conditions of the pixels in the image are comprehensively determined with reference to the image features before and after reconstruction and a discrimination result determined based on the difference information between the image features before and after reconstruction, so that pixel-level image anomaly detection can be implemented while ensuring accuracy of image anomaly detection. In addition, the discriminator is obtained through training based on the composite image sample that is composited based on a normal image sample. Therefore, an anomalous image does not need to be collected and labeled manually in a training process of the discriminator, and training may be performed in a manner of unsupervised learning, so that a quantity of samples that can be used during training of the discriminator can be increased, an effect of training the discriminator by using the composite image sample is improved, and a difference from an effect of training the discriminator by using a real anomalous image is reduced, to ensure accuracy of the discriminator, thereby ensuring accuracy of anomaly detection performed on the pixels of the image through the discriminator.

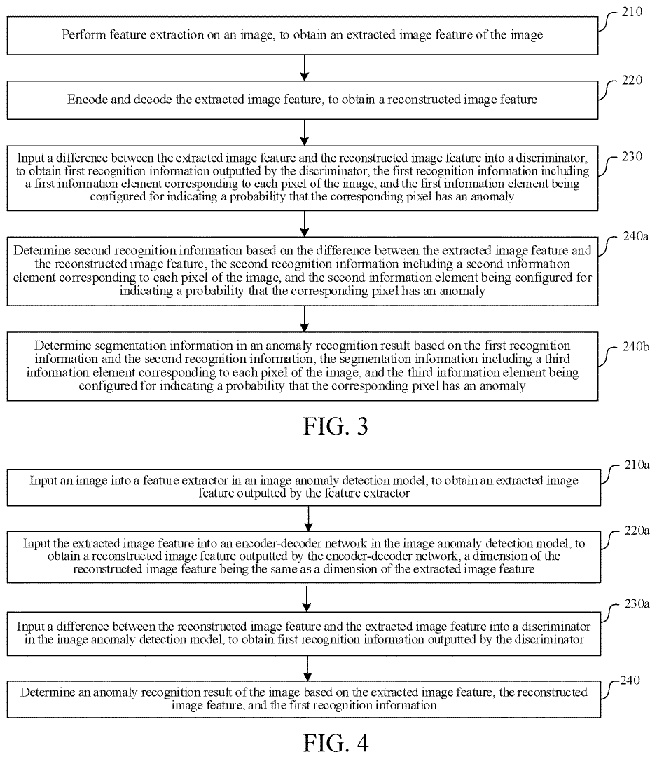

Based on the embodiment shown in FIG. 2, FIG. 3 is a schematic flowchart of an image processing method according to an embodiment. As shown in FIG. 3, operation 240 may be implemented as operation 240a and operation 240b.

Operation 240a: Determine second recognition information based on the difference between the extracted image feature and the reconstructed image feature, the second recognition information including a second information element corresponding to each pixel of the image, and the second information element being configured for indicating a probability that the corresponding pixel has an anomaly. For example, second recognition information is determined based on the difference information between the extracted image feature and the reconstructed image feature. In some embodiments, the second recognition information includes second information elements, each one of the second information elements indicating a second probability of a respective pixel of the image having an anomaly.

For example, the second recognition information includes H×W second information elements, the H×W second information elements are in one-to-one correspondence with the H×W pixels included in the image in operation 210, and the second information elements are configured for indicating the probability that the corresponding pixel has an anomaly.

The second information element may be a probability value, and the probability value indicates the probability that the corresponding pixel has an anomaly. Alternatively, the second information element may be an anomaly score, and the anomaly score may be positively correlated or negatively correlated to the probability that the corresponding pixel has an anomaly.

In some embodiments, a dimension of the difference between the extracted image feature and the reconstructed image feature is less than a quantity of pixels of a target image; and the determining second recognition information based on the difference between the extracted image feature and the reconstructed image feature may include: obtaining an L2 norm of the difference information between the extracted image feature and the reconstructed image feature, and upsampling the L2 norm, to obtain the second recognition information.

In at least one embodiment of this disclosure, the computer device may subtract the reconstructed image feature from the extracted image feature element by element, to obtain the difference information between the extracted image feature and the reconstructed image feature, and upsample the L2 norm after obtaining the L2 norm of the difference information between the extracted image feature and the reconstructed image feature, to obtain the second recognition information.

For example, dimensions of the extracted image feature and the reconstructed image feature are both h×w, h×w being less than H×W (namely, the quantity of pixels included in the image), for example, h=H/16, and w=W/16. The computer device calculates the L2 norm after subtracting features of the same dimension in the extracted image feature and the reconstructed image feature, a dimension of the L2 norm being also h×w, and then performs upsampling (for example, performs upsampling by means of bilinear interpolation processing) on a calculation result (that is, the L2 norm), to obtain the second recognition information that also includes H×W elements (namely, the second information elements).

The subtracting features of the same dimension in the extracted image feature and the reconstructed image feature refers to subtracting a feature element in an i^{th} row and a j^{th} column in the reconstructed image feature from a feature element in an i^{th} row and a j^{th} column in the extracted image feature, i including an integer greater than or equal to 1 and less than or equal to h, and j including an integer greater than or equal to 1 and less than or equal to w. Finally, h×w subtraction results are obtained.

In at least one embodiment of this disclosure, the computer device, after interacting and reconstructing the extracted image feature, calculates the L2 norm of the features before and after interaction and reconstruction, to detect whether each pixel of the image has an anomaly, so as to ensure that image anomaly detection based on a reconstruction error of the image feature can be implemented.

Operation 240b: Determine segmentation information in the anomaly recognition result based on the first recognition information and the second recognition information, the segmentation information including a third information element corresponding to each pixel of the image, and the third information element being configured for indicating a probability that the corresponding pixel has an anomaly. For example, segmentation information in the anomaly recognition result is determined based on the first recognition information and the second recognition information. In some embodiments, the segmentation information includes third information elements, each one of the third information elements indicating a third probability of a respective pixel of the image having an anomaly. In some embodiments, the anomaly recognition result is determined based on the segmentation information.

For example, the segmentation information includes H×W third information elements, the H×W third information elements are in one-to-one correspondence with the H×W pixels in the image in operation 210, and the third information element is configured for indicating a probability that a corresponding pixel has an anomaly.

The third information element may be a probability value, and the probability value indicates the probability that the corresponding pixel has an anomaly. Alternatively, the third information element may be an anomaly score, and the anomaly score may be positively correlated to or negatively correlated the probability that the corresponding pixel has an anomaly.

In at least one embodiment of this disclosure, dimensions of the first recognition information and the second recognition information are the same, and are both H×W. When the segmentation information in the anomaly recognition result is determined, a third information element corresponding to each dimension may be determined, to obtain the segmentation information that also has H×W elements.

For example, the determining a third information element corresponding to each dimension may be determining a third information element in an m^{th} row and an n^{th} column in the segmentation information with reference to a first information element in an m^{th} row and an n^{th} column in the first recognition information and a second information element in an m^{th} row and an n^{th} column in the second recognition information, m including an integer greater than or equal to 1 and less than or equal to H, and n including an integer greater than or equal to 1 and less than or equal to W. Finally, the H×W third information elements in the segmentation information are obtained.

With reference to the reconstruction error of the image feature, the computer device comprehensively determines the anomaly conditions of the pixels in the image through the discriminator based on the difference information between the image features before and after reconstruction, to ensure accuracy of pixel-level anomaly detection.

In a possible implementation, the determining segmentation information in the anomaly recognition result based on the first recognition information and the second recognition information includes:
performing weighted summation or weighted averaging on the first recognition information and the second recognition information, to obtain the segmentation information.

For example, the computer device may perform weighted summation or weighted averaging on information elements of the same dimension in the first recognition information and the second recognition information, to obtain H×W weighted summation or weighted averaging results. The H×W weighted summation or weighted averaging results are the third information elements, to form the segmentation information.

For example, the performing weighted summation or weighted averaging on information elements of the same dimension in the first recognition information and the second recognition information may be performing weighted summation or weighted averaging on the first information elements in the m^{th} row and the n^{th} column in the first recognition information and the second information elements in the m^{th} row and the n^{th} column in the second recognition information, to obtain the third information elements in the m^{th} row and the n^{th} column in the segmentation information, m including an integer greater than or equal to 1 and less than or equal to H, and n including an integer greater than or equal to 1 and less than or equal to W. Finally, the H×W third information elements in the segmentation information are obtained.

In at least one embodiment of this disclosure, the computer device performs weighted summation or weighted average processing on the information elements of the same dimension in the first recognition information and the second recognition information, to flexibly adjust a proportion of the first recognition information and the second recognition information by setting a weight, thereby ensuring flexibility and accuracy of obtaining the segmentation information with reference to the first recognition information and the second recognition information.

In a possible implementation, the method further includes:
determining an image classification result in the anomaly recognition result based on the segmentation information, the image classification result being configured for indicating a probability that the image is an anomalous image.

The image classification result may be a probability value, and the probability value indicates a probability that the image in operation 210 is an anomalous image. Alternatively, the image classification result may be an anomaly score, and the anomaly score may be positively correlated or negatively correlated to a probability that the image in operation 210 is an anomalous image.

In at least one embodiment of this disclosure, the segmentation information is a pixel-level anomaly recognition result. In other words, the segmentation information is configured for indicating whether each pixel of the image has an anomaly. Based on this, the computer device may further obtain an image-level anomaly recognition result based on the segmentation information. In other words, the image classification result is configured for indicating whether the image is an anomalous image as a whole, to improve diversity of the anomaly recognition results of the image, thereby expanding applicable scenarios of image anomaly recognition.

In a possible implementation, the determining an image classification result in the anomaly recognition result based on the segmentation information includes:
obtaining a maximum value or a standard deviation of third information elements in the segmentation information, to obtain the image classification result.

In at least one embodiment of this disclosure, the computer device uses the maximum value or the standard deviation of the third information elements in the segmentation information as an image-level anomaly detection result, to provide an implementable solution of determining the image-level anomaly recognition result by using the pixel-level anomaly recognition result, thereby ensuring accuracy of the image-level anomaly recognition result.

Based on the embodiment shown in FIG. 2 or FIG. 3, FIG. 4 is a schematic flowchart of an image processing method according to an embodiment. As shown in FIG. 4, operation 210, operation 220, and operation 230 may be respectively implemented as operation 210a, operation 220a, and operation 230a.

Operation 210a: Input an image into a feature extractor in an image anomaly detection model, to obtain an extracted image feature outputted by the feature extractor.

For example, a dimension of image data received by an input end of the feature extractor is 3×H×W, corresponding to the H×W pixels in the image, and each pixel corresponds to data of three channels (for example, values of R, G, and B). The feature extractor outputs the extracted image feature with the dimension of h×w after processing the input image data with the data dimension of 3×H×W.

Operation 220a: Input the extracted image feature into an encoder-decoder network in the image anomaly detection model, to obtain a reconstructed image feature outputted by the encoder-decoder network, a dimension of the reconstructed image feature being the same as a dimension of the extracted image feature.

For example, a dimension of the extracted image feature received by an input end of the encoder-decoder network is h×w. The encoder-decoder network may output the reconstructed image feature with the same dimension of h×w after processing the extracted image feature with the dimension of h×w.

Operation 230a: Input difference information between the reconstructed image feature and the extracted image feature into a discriminator in the image anomaly detection model, to obtain first recognition information outputted by the discriminator.

For example, a dimension of the difference information between the reconstructed image feature and the extracted image feature received by an input end of the discriminator is h×w. The discriminator may output the first recognition information with the dimension of H×W after processing the difference information between the image features before and after reconstruction with the dimension of h×w.

The image anomaly detection model is a machine learning model obtained through unsupervised training based on a first image sample. The first image sample is an image sample having no anomaly.

In at least one embodiment of this disclosure, the computer device performs anomaly recognition on the image by using the pre-trained image anomaly detection model, to ensure efficiency and accuracy of image anomaly recognition.

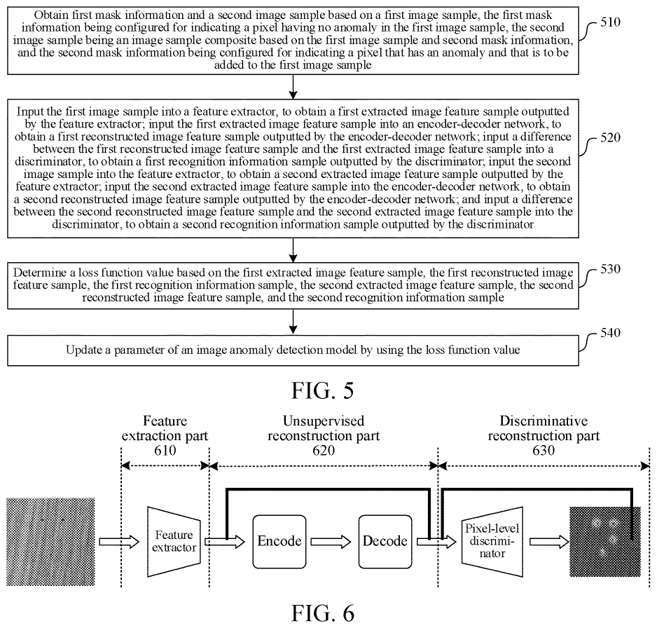

Based on the embodiment shown in FIG. 4, FIG. 5 is a schematic flowchart of an image processing method according to an embodiment. The method may be performed by the computer device. For example, the computer device may be a server, or the computer device may be a terminal, or the computer device may include a server and a terminal. The server may be the server 160 in the embodiment as shown in FIG. 1, and the terminal may be the terminal 140 used by the developer in the embodiment as shown in FIG. 1. The computer device may be implemented as a model training device configured to perform model training. As shown in FIG. 5, before operation 210, the method may include the following operations.

Operation 510: Obtain first mask information and a second image sample based on a first image sample, the first mask information being configured for indicating a pixel having no anomaly in the first image sample, the second image sample being an image sample composited based on the first image sample and second mask information, and the second mask information being configured for indicating a pixel that has an anomaly and that is to be added to the first image sample.

Because the first image sample is an image sample having no anomaly, the first mask information may directly indicate that none of pixels in the first image sample has an anomaly. For example, assuming that a dimension of the first image sample is H×W, the first mask information may be a two-dimensional matrix with a dimension of H×W. Each dimension in the two-dimensional matrix corresponds to one pixel in the first image sample. A value of the each dimension in the two-dimensional matrix may be, for example, 0, configured for indicating that none of the pixels in the first image sample has an anomaly.

The computer device may obtain the second mask information preset by the developer, or generate the second mask information in various manners, to indicate a pixel that has an anomaly and that is to be deployed based on the first image sample. For example, assuming that the dimension of the first image sample is H×W, the second mask information may be a two-dimensional matrix with a dimension of H×W. Each dimension in the two-dimensional matrix corresponds to one pixel in the first image sample, and a value of the each dimension in the two-dimensional matrix is configured for indicating whether the corresponding pixel shall be a pixel having an anomaly. For example, if a value of a dimension in the two-dimensional matrix is 1, it indicates that the corresponding pixel in the first image sample shall have an anomaly, and if the value of the dimension is 0, it indicates that the corresponding pixel in the first image sample shall be normal.

In addition, the computer device may further composite the second image sample based on the second mask information and the first image sample. For example, the computer device may modify a value of a corresponding pixel in the first image sample based on the pixel having an anomaly indicated by the second mask information, for example, replace the value of the pixel that has an anomaly and that is indicated by the second mask information in the first image sample with a different value, to obtain the second image sample.

Operation 520: Input the first image sample into a feature extractor, to obtain a first extracted image feature sample outputted by the feature extractor; input the first extracted image feature sample into an encoder-decoder network, to obtain a first reconstructed image feature sample outputted by the encoder-decoder network; input difference information between the first reconstructed image feature sample and the first extracted image feature sample into a discriminator, to obtain a first recognition information sample outputted by the discriminator; input the second image sample into the feature extractor, to obtain a second extracted image feature sample outputted by the feature extractor; input the second extracted image feature sample into the encoder-decoder network, to obtain a second reconstructed image feature sample outputted by the encoder-decoder network; and input difference information between the second reconstructed image feature sample and the second extracted image feature sample into the discriminator, to obtain a second recognition information sample outputted by the discriminator.

A process in which branch parts (namely, the feature extractor, the encoder-decoder network, and the discriminator) in the image anomaly detection model process the first image sample and the second image sample to obtain the recognition information sample is similar to a process in which the branch parts in the image anomaly detection model process the image to obtain the first recognition information, and details are not described herein again.

Operation 530: Determine a loss function value based on the first extracted image feature sample, the first reconstructed image feature sample, the first recognition information sample, the second extracted image feature sample, the second reconstructed image feature sample, and the second recognition information sample.

In at least one embodiment of this disclosure, in a model training process, the first mask information and the second mask information are equivalent to labeled information respectively corresponding to the first image sample and the second image sample. Loss function calculation may be performed based on the labeled information, and intermediate data and an output result obtained in a process of processing the image sample by the image anomaly detection model.

In a possible implementation, the determining a loss function value based on the first extracted image feature sample, the first reconstructed image feature sample, the first recognition information sample, the second extracted image feature sample, the second reconstructed image feature sample, and the second recognition information sample includes:
determining a first loss function value based on difference information between the first extracted image feature sample and the first reconstructed image feature sample;
determining a second loss function value based on difference information between the first recognition information sample and the first mask information;
determining a third loss function value based on difference information between the second extracted image feature sample and the second reconstructed image feature sample; and
determining a fourth loss function value based on difference information between the second recognition information sample and the second mask information.

In a loss function calculation process, the first loss function value and the third loss function value are losses generated in a process in which the image anomaly detection model performs reconstruction on a feature of the image sample, and the second loss function value and the fourth loss function value are losses generated in a process in which the image anomaly detection model performs prediction on a pixel having an anomaly in the input image sample.

The branch parts in the image anomaly detection model are trained with reference to the loss generated in the reconstruction process and the loss generated in the anomalous pixel prediction process, so that both image feature reconstruction performance and anomaly prediction performance of the image anomaly detection model can be enhanced, thereby helping the image anomaly detection model to generate a more accurate detection result in an application stage.

Operation 540: Update a parameter of the image anomaly detection model by using the loss function value.

For example, the computer device may perform parameter update on the feature extractor and the encoder-decoder network by using the first loss function value and the third loss function value, and perform parameter update on the feature extractor, the encoder-decoder network, and the discriminator by using the second loss function value and the fourth loss function value.

This disclosure provides a model training method of unsupervised+discriminative reconstruction, to train an image anomaly detection model implementing image anomaly detection. In some examples, the method provides a pixel-level discriminator to further enhance differentiation between a normal sample and an anomalous sample and refine a reconstruction error. In an inference stage, results of the unsupervised reconstruction and the pixel-level discriminator are integrated, to significantly improve pixel-level anomaly segmentation.

FIG. 6 is a diagram of an architecture of an unsupervised+discriminative reconstruction network according to this disclosure. As shown in FIG. 6, the network architecture mainly includes three modules: a feature extraction part 610, an unsupervised reconstruction part 620, and a pixel-level discriminative reconstruction part 630.

The following separately describes the three parts in the network architecture.

(1) Feature extraction: Following existing anomaly detection work, Image feature extraction is performed though a pre-training model on ImageNet. Given an input image I∈ [symbol] , for example, in this disclosure, a multi-scale feature map

$${\{ {Z}_{i} \}}_{i = 1}^{4}$$

is extracted from stages 1 to 4 of a pre-training convolutional network [symbol] (for example, EfficientNet-b4), that is:

$${Z}_{i} = ℱ ( I )$$

Zᵢ∈ [symbol] , cᵢ represents a channel number, and hᵢ×wᵢ represents an i^{th} space-size-level feature map. Considering a weak semantic but high resolution of a feature map at a lowest layer, performance enhancement is limited but calculation costs are high. To combine features

$${\{ {Z}_{i} \}}_{i = 1}^{4}$$

of different hierarchical structures, sizes of all feature maps are adjusted to a same size (h₄×w₄), that is, a size of a smallest feature map. These adjusted feature maps are connected in a channel dimension. An entire process may be expressed as:

$$F = concat ( {\{ resize ( {Z}_{i} , ( h , w ) ) \}}_{i = 1}^{4} )$$

F∈ [symbol] ,

$$c = {\sum }_{i = 1}^{4} {c}_{i} ,$$

h=h₄, anu w=w₄.

The feature extraction part 610 may use any pre-training model based on a convolutional neural network or a Transformer architecture.

(2) Unsupervised reconstruction: The unsupervised reconstruction follows a standard Transformer architecture, and includes two parts: encoding and decoding. First, a linear projection layer to which position embedding is added is used to perform dimension reduction on a multi-level feature F extracted from the pre-training model, and then global interaction and reconstruction are performed on the feature by using an encoding structure and a decoding structure that are formed by a series of Transformer blocks. Each Transformer block includes a multi-head attention network and a fully-connected feed forward network. Finally, dimension raising is performed on an output result of the decoding structure by using a linear projection layer, to restore to an original input feature dimension, and an output is denoted as \hat{F}. A mean square error (MSE) between a reconstructed feature and an original feature is calculated by using a reconstruction loss function, that is:

$${ℒ}_{res} = \frac{1}{c \times h \times w} {\sum }_{i = 1}^{c} {\sum }_{j = 1}^{h} {\sum }_{k = 1}^{w} {( {F}_{i , j , k} - {\hat{F}}_{i , j , k} )}^{2}$$

In some examples, a possible network structure of the unsupervised reconstruction part may be a Transformer, a convolutional neural network, a fully-connected neural network, or the like.

(3) Discriminative reconstruction: Performance of anomaly segmentation is still poor when only unsupervised reconstruction is used. Because training is performed only on training data having no anomaly, a “weak discrimination line” between a normal sample and an anomalous sample in a feature space may be caused. In at least one example, when a difference between the normal sample and the anomalous sample is not significant, it is difficult for a trained model to recognize the anomalous sample. Therefore, to train a discriminator to enhance differentiation between the normal sample and the anomalous sample, a simplest implementation is to train a binary classifier based on a normal image and a defective image. However, for an unsupervised anomaly detection task, usually only the normal image can be obtained as a training sample. Actually, this is also a setting of an actual industrial detection application. This is because defective products are rare and are difficult to be collected on a large scale. To train the discriminator, the defective image may be composited by using the normal image. In this disclosure, the defective image may be composited at a pixel level, so that the discriminator is trained based on the composited image. In addition, in this disclosure, a lightweight discriminator is designed, to refine a reconstruction error of a double mask automatic encoder-decoder network.

Given a normal training image Iⁿ and a corresponding anomaly mask Yⁿ, a defective image composited by using the normal training image and the anomaly mask is represented by I^{s} and Y^{s}. Then, the normal image and the composite defective image {I^{t}|t=n, s} are input into a multi-level feature extractor, and a multi-level feature is exported as {F^{t}|t=n, s}. Then, {F^{t}|t=n, s} is reconstructed by using an unsupervised reconstruction network, and a corresponding feature is represented by {\hat{F}^{t}=n, s}. In this disclosure, element-by-element subtraction of the original feature and the reconstructed feature is used to measure a difference between the original feature and the reconstructed feature, that is:

$${E}^{t} = \vert {F}^{t} - {\hat{F}}^{t} \vert , t = n , s$$

The discriminator is designed with a plurality of convolution blocks to learn a feature, followed by a 1×1 convolution layer for pixel segmentation. Each convolution block includes 3×3 convolution, BatchNorm, ReLU, and 2×2 deconvolution. An absolute reconstruction error {E^{t}|t=n, s} is input into the designed discriminator, and an estimated anomaly image Ŷ^{t} is obtained. To calculate a loss between Ŷ^{t} and a true value Y^{t}, a size of Ŷ^{t} is adjusted to a size of Y^{t}. Considering that an anomalous pixel is usually in a minority in anomaly detection, a loss function may be calculated by using Dice loss, which is effective for learning from extremely imbalanced data, that is:

$${ℒ}_{res} = 1 - \frac{2 {\sum }_{i = 1}^{H} {\sum }_{j = 1}^{W} {\hat{Y}}_{i , j}^{t} {Y}_{i , j}^{t}}{{\sum }_{i = 1}^{H} {\sum }_{j = 1}^{W} {\hat{Y}}_{i , j}^{{t}^{2}} + {\sum }_{i = 1}^{H} {\sum }_{j = 1}^{W} {Y}_{i , j}^{{t}^{2}}}$$

(i, j) represents a spatial position of Y^{t} or Ŷ^{t}.

A process of anomaly inference is as follows.

Pixel-level anomaly segmentation: A result of anomaly segmentation is an anomaly score graph allocating an anomaly score to each pixel. For unsupervised reconstruction, the anomaly score graph is calculated as an upsampling result of a L₂ norm of a reconstruction error, shown as follows:

$${S}_{res} = {‖ F - \hat{F} ‖}_{2} ∈ {ℝ}^{H \times W}$$

For discriminative reconstruction, the anomaly score graph is predicted as Ŷ∈ [symbol] . Finally, Sᵣₑₛ and Ŷ are combined, to be used as a final anomaly segmentation graph, that is:

$$S = ω \cdot {S}_{res} + ( 1 - ω ) \cdot \hat{Y}$$

ω∈[0,1] represents a weight.

Image-level anomaly classification: Anomaly classification aims to detect whether an image includes an anomalous region. A maximum value or a standard deviation is calculated in a space dimension based on a pixel-level prediction error S, to be converted into an image-level anomaly score.

Experiment setting: EfficientNet-b4 pre-trained on ImageNet is selected as a basic extracted network feature. A size of an input image is 224×224. Features of three stages are extracted and scaled to the same size 14×14, and finally undergoes channel dimension concatenation, to form an original feature with a dimension of 272×14×14. An encoder and a decoder each use a plurality of Transformer blocks.

Main experimental conclusions are as follows.

(1) This solution can resolve inaccurate positioning and segmentation of an unsupervised reconstruction method at a defective pixel level.

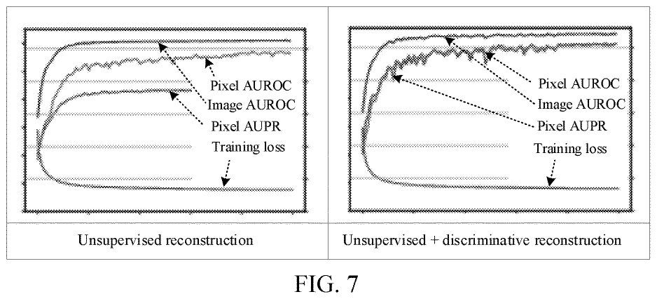

FIG. 7 is a comparison diagram of a test result according to this disclosure. FIG. 7 shows a schematic diagram of a comparison between a training loss and a test indicator on an MVTec data set with respect to the unsupervised reconstruction network and an encoding and decoding network of unsupervised+discriminative reconstruction provided in this disclosure.

A result indicates that the common unsupervised reconstruction network shows good performance only on image-level defect detection. The encoding and decoding network of unsupervised+discriminative reconstruction provided in this disclosure has significant performance enhancement on pixel-level defect segmentation.

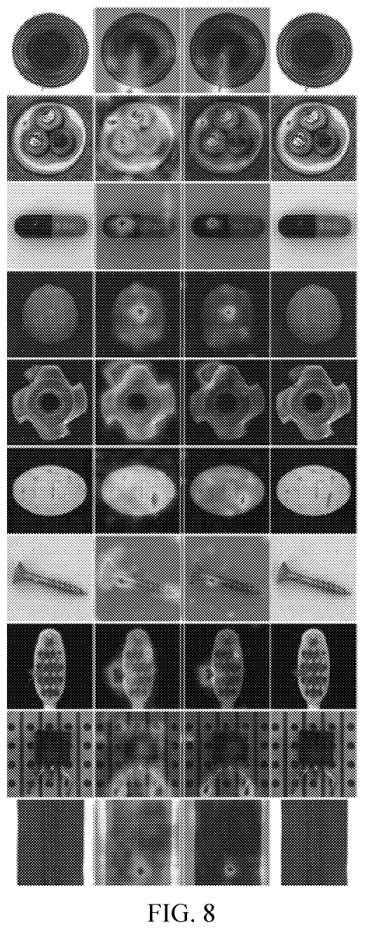

(2) In this solution, performance on unified anomaly detection of a real industrial anomaly detection data set is significantly enhanced, especially on pixel-level anomaly segmentation. FIG. 8 is a schematic diagram of an anomaly recognition comparison according to this disclosure. As shown in FIG. 8, for 15 categories of MVTec, compared with the unsupervised anomaly detection method (a 2^{nd} column) on, an anomaly detection boundary of the method provided in this solution (a 3^{rd} column) is more refined and accurate, and is closer to a manually labeled true value (a 4^{th} column).

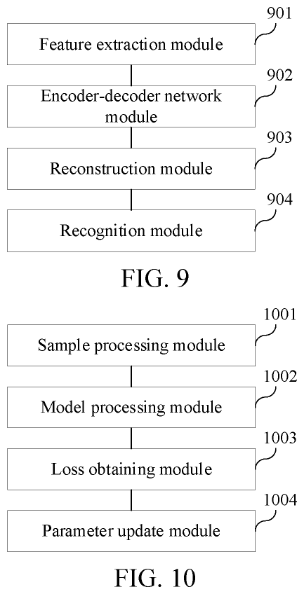

FIG. 9 is a block diagram of a structure of an image processing apparatus according to an embodiment of this disclosure. As shown in FIG. 9, the apparatus includes the following parts:
a feature extraction module 901, configured to perform feature extraction on an image, to obtain an extracted image feature of the image;
an encoder-decoder network module 902, configured to encode and decode the extracted image feature, to obtain a reconstructed image feature;
a reconstruction module 903, configured to input difference information between the extracted image feature and the reconstructed image feature into a discriminator, to obtain first recognition information outputted by the discriminator, the first recognition information including a first information element corresponding to each pixel of the image, and the first information element being configured for indicating a probability that the corresponding pixel has an anomaly; and the discriminator being a machine learning model obtained through training based on a composite image sample, and the composite image sample being an image sample that has an anomaly and that is composite based on an image sample having no anomaly; and
a recognition module 904, configured to determine an anomaly recognition result of the image based on the extracted image feature, the reconstructed image feature, and the first recognition information.

In a possible implementation, the recognition module 904 is configured to:
determine second recognition information based on the difference information between the extracted image feature and the reconstructed image feature, the second recognition information including a second information element corresponding to each pixel of the image, and the second information element being configured for indicating a probability that the corresponding pixel has an anomaly; and
determine segmentation information in the recognition result based on the first recognition information and the second recognition information, the segmentation information including a third information element corresponding to each pixel of the image, and the third information element being configured for indicating a probability that the corresponding pixel has an anomaly.

In a possible implementation, a dimension of the difference information between the extracted image feature and the reconstructed image feature is less than a quantity of pixels of the image; and the recognition module 904 is configured to obtain an L2 norm of the difference information between the extracted image feature and the reconstructed image feature, and upsample the L2 norm, to obtain the second recognition information.

In a possible implementation, the recognition module 904 is configured to perform weighted summation or weighted averaging on the first recognition information and the second recognition information, to obtain the segmentation information.

In a possible implementation, the recognition module 904 is further configured to determine an image classification result in the anomaly recognition result based on the segmentation information, the image classification result being configured for indicating a probability that the image is an anomalous image.

In a possible implementation, the recognition module 904 is further configured to obtain a maximum value or a standard deviation of third information elements in the segmentation information, to obtain the image classification result.

In a possible implementation, the feature extraction module 901 is configured to input the image into a feature extractor in an image anomaly detection model, to obtain the extracted image feature outputted by the feature extractor;
the encoder-decoder network module 902 is configured to input the extracted image feature into an encoder-decoder network in the image anomaly detection model, to obtain the reconstructed image feature outputted by the encoder-decoder network, a dimension of the reconstructed image feature being the same as a dimension of the extracted image feature; and
the reconstruction module 903 is configured to input the difference information between the extracted image feature and the reconstructed image feature into the discriminator in the image anomaly detection model, to obtain the first recognition information outputted by the discriminator,
the image anomaly detection model being a machine learning model obtained through unsupervised training based on a first image sample; and the first image sample being an image sample having no anomaly.

In a possible implementation, the apparatus further includes:
a sample processing module, configured to obtain, before the feature extraction module performs feature extraction on the image to obtain the extracted image feature of the image, first mask information and a second image sample based on the first image sample, the first mask information being configured for indicating a pixel having no anomaly in the first image sample, the second image sample being an image sample composited based on the first image sample and second mask information, and the second mask information being configured for indicating a pixel that has an anomaly and that is to be added to the first image sample;
a model processing module, configured to input the first image sample into the feature extractor, to obtain a first extracted image feature sample outputted by the feature extractor; input the first extracted image feature sample into the encoder-decoder network, to obtain a first reconstructed image feature sample outputted by the encoder-decoder network; input difference information between the first reconstructed image feature sample and the first extracted image feature sample into the discriminator, to obtain a first recognition information sample outputted by the discriminator; input the second image sample into the feature extractor, to obtain a second extracted image feature sample outputted by the feature extractor; input the second extracted image feature sample into the encoder-decoder network, to obtain a second reconstructed image feature sample outputted by the encoder-decoder network; and input difference information between the second reconstructed image feature sample and the second extracted image feature sample into the discriminator, to obtain a second recognition information sample outputted by the discriminator;
a loss obtaining module, configured to determine a loss function value based on the first extracted image feature sample, the first reconstructed image feature sample, the first recognition information sample, the second extracted image feature sample, the second reconstructed image feature sample, and the second recognition information sample; and
a parameter update module, configured to update a parameter of the image anomaly detection model by using the loss function value.

In a possible implementation, the loss obtaining module is configured to:
determine a first loss function value based on difference information between the first extracted image feature sample and the first reconstructed image feature sample;
determine a second loss function value based on difference information between the first recognition information sample and the first mask information;
determine a third loss function value based on difference information between the second extracted image feature sample and the second reconstructed image feature sample; and
determine a fourth loss function value based on difference information between the second recognition information sample and the second mask information.

Therefore, based on one or more embodiments of this disclosure, after the extracted image feature is extracted from the image, feature reconstruction is performed on the extracted image feature in an encoding and decoding manner, to obtain the reconstructed image feature. Further, anomaly discrimination is performed through the discriminator based on the difference information between the reconstructed image feature and the extracted image feature, to obtain the first recognition information indicating the probability that each pixel of the image has an anomaly. Finally, the anomaly recognition result of the image is comprehensively obtained with reference to the image features before and after reconstruction and the first recognition information. In the foregoing solution, in addition to recognizing anomaly conditions of the pixels in the image by using the image features before and after reconstruction, the anomaly conditions of the pixels in the image are further determined through the discriminator based on the difference information between the image features before and after reconstruction. In this way, the anomaly conditions of the pixels in the image are comprehensively determined with reference to the image features before and after reconstruction and a discrimination result determined based on the difference information between the image features before and after reconstruction, so that pixel-level image anomaly detection can be implemented while ensuring accuracy of image anomaly detection. In addition, the discriminator is obtained through training based on the composite image sample that is composited based on a normal image sample. Therefore, an anomalous image does not need to be collected and labeled manually in a training process of the discriminator, and training may be performed in a manner of unsupervised learning, so that a quantity of samples that can be used during training of the discriminator can be increased, an effect of training the discriminator by using the composite image sample is improved, and a difference from an effect of training the discriminator by using a real anomalous image is reduced, to ensure accuracy of the discriminator, thereby ensuring accuracy of anomaly detection performed on the pixels of the image through the discriminator.

FIG. 10 is a block diagram of a structure of an image processing apparatus according to an embodiment of this disclosure. As shown in FIG. 9, the apparatus includes the following parts:
a sample processing module 1001, configured to obtain first mask information and a second image sample based on a first image sample, the first mask information being configured for indicating a pixel having no anomaly in the first image sample, the second image sample being an image sample composited based on the first image sample and second mask information, and the second mask information being configured for indicating a pixel that has an anomaly and that is to be added to the first image sample;
a model processing module 1002, configured to input the first image sample into a feature extractor in an image anomaly detection model, to obtain a first extracted image feature sample outputted by the feature extractor; input the first extracted image feature sample into an encoder-decoder network in the image anomaly detection model, to obtain a first reconstructed image feature sample outputted by the encoder-decoder network; input difference information between the first reconstructed image feature sample and the first extracted image feature sample into a discriminator in the image anomaly detection model, to obtain a first recognition information sample outputted by the discriminator; input the second image sample into the feature extractor, to obtain a second extracted image feature sample outputted by the feature extractor; input the second extracted image feature sample into the encoder-decoder network, to obtain a second reconstructed image feature sample outputted by the encoder-decoder network; and input difference information between the second reconstructed image feature sample and the second extracted image feature sample into the discriminator, to obtain a second recognition information sample outputted by the discriminator;
a loss obtaining module 1003, configured to determine a loss function value based on the first extracted image feature sample, the first reconstructed image feature sample, the first recognition information sample, the second extracted image feature sample, the second reconstructed image feature sample, and the second recognition information sample; and
a parameter update module 1004, configured to update a parameter of the image anomaly detection model by using the loss function value,
the image anomaly detection model being configured to implement the image processing method shown in FIG. 2 to FIG. 4.

In a possible implementation, the loss obtaining module is configured to:
determine a first loss function value based on difference information between the first extracted image feature sample and the first reconstructed image feature sample;
determine a second loss function value based on difference information between the first recognition information sample and the first mask information;
determine a third loss function value based on difference information between the second extracted image feature sample and the second reconstructed image feature sample; and
determine a fourth loss function value based on difference information between the second recognition information sample and the second mask information.

The image processing apparatus provided in the foregoing embodiment is illustrated only with an example of division of the foregoing function modules. In some examples, the foregoing functions may be allocated to and implemented based on different function modules based on a requirement. That is, an internal structure of the apparatus is divided into different function modules to implement all or some of the functions described above. In addition, the image processing apparatus provided in the foregoing embodiment belongs to the same conception as the image processing method embodiment. For details of the implementation of a corresponding processing method, reference can be made to the method embodiment, and details are not described herein again.

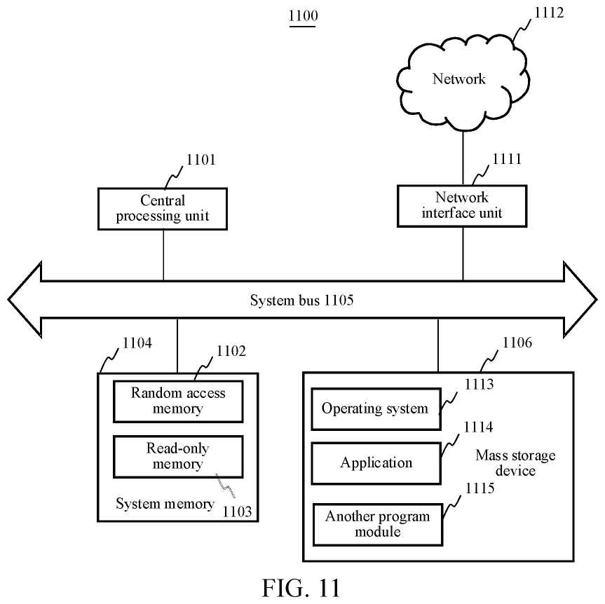

FIG. 11 is a schematic diagram of a structure of a server according to an embodiment of this disclosure.

A server 1100 includes processing circuitry (e.g., a central processing unit (CPU) 1101), a system memory 1104 including a random access memory (RAM) 1102 and a read-only memory (ROM) 1103, and a system bus 1105 connecting the system memory 1104 and the central processing unit 1101. The server 1100 further includes a mass storage device 1106 configured to store an operating system 1113, an application 1114, and another program module 1115.

The mass storage device 1106 is connected to the central processing unit 1101 by using a mass storage controller (not shown) that is connected to the system bus 1105. The mass storage device 1106 and a non-transitory computer-readable medium associated with the mass storage device 1106 provide non-volatile storage for the server 1100. In other words, the mass storage device 1106 may include a non-transitory computer-readable medium (not shown) such as a hard disk or a compact disc read-only memory (CD-ROM) drive.

In some examples, a computer storage medium may include volatile and non-volatile media, and removable and non-removable media that are implemented by any method or technology for storing information such as computer-readable instructions, data structures, program modules, or other data. The computer storage medium includes a RAM, a ROM, an erasable programmable read-only memory (EPROM), an electrically erasable programmable read-only memory (EEPROM), a flash memory or another solid state storage technology, a CD-ROM, a digital versatile disc (DVD) or another optical memory, a tape cartridge, a magnetic tape, a magnetic disk memory, or another magnetic storage device. Certainly, a person skilled in art can know that the computer storage medium is not limited to the foregoing several types. The system memory 1104 and the mass storage device 1106 may be collectively referred to as a memory.

According to embodiments of this disclosure, the server 1100 may further be connected, through a network such as the Internet, to a remote computer on the network and run. In at least one example, the server 1100 may be connected to a network 1112 by using a network interface unit 1111 that is connected to the system bus 1105, or may be connected to another type of network or a remote computer system (not shown) by using the network interface unit 1111.

The memory further includes a non-transitory computer-readable storage medium storing one or more programs. The one or more programs are stored in the memory (e.g., a non-transitory computer-readable storage medium) and configured to be executed by the CPU.

An embodiment of this disclosure further provides a computer device. The computer device includes processing circuitry (e.g., a processor) and a memory (e.g., including a non-transitory computer-readable storage medium). The memory has at least one instruction, at least one program, a code set, or an instruction set stored therein. The at least one instruction, the at least one program, the code set, or the instruction set is loaded and executed by the processor to implement the image processing method provided in the foregoing method embodiments.

An embodiment of this disclosure further provides a non-transitory computer-readable storage medium. The non-transitory computer-readable storage medium has at least one instruction, at least one program, a code set, or an instruction set stored therein. The at least one instruction, the at least one program, the code set, or the instruction set is loaded and executed by processing circuitry (e.g., a processor) to implement the image processing method provided in the foregoing method embodiments.

An embodiment of this disclosure further provides a computer program product or a computer program. The computer program product or the computer program includes computer instructions. The computer instructions are stored in a non-transitory computer-readable storage medium. Processing circuitry (e.g., a processor) of a computer device reads the computer instructions from the non-transitory computer-readable storage medium, and the processor executes the computer instructions, so that the computer device performs the image processing method according to any one of the foregoing embodiments.

In some embodiments, the non-transitory computer-readable storage medium may include: a read-only memory (ROM), a random access memory (RAM), a solid state drive (SSD), an optical disc, or the like. The random access memory may include a resistance random access memory (ReRAM), and a dynamic random access memory (DRAM). The sequence numbers of the foregoing embodiments of this disclosure are merely for description purposes, and are not intended to indicate priorities of the embodiments.

A person of ordinary skill in the art may understand that all or some of the operations of one or more embodiments described in this disclosure may be implemented by hardware, or may be implemented by a program instructing relevant hardware. The program may be stored in a non-transitory computer-readable storage medium. The non-transitory storage medium may be a read-only memory, a magnetic disk, an optical disc, or the like.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The foregoing descriptions are merely non-limiting embodiments of this disclosure, but is not intended to limit this disclosure. Any modification, equivalent replacement, or improvement made within the spirit and principle of this disclosure falls within the scope of this disclosure.

What is claimed is:

1. An image processing method, the method comprising:
extracting, by processing circuitry, an image feature of an image;
obtaining a reconstructed image feature based on encoding the extracted image feature and decoding the encoded image feature;
obtaining, by the processing circuitry through a discriminator, first recognition information based on difference information between the extracted image feature and the reconstructed image feature, the first recognition information including first information elements, each one of the first information elements indicating a first probability of a respective pixel of the image having an anomaly; and
determining, by the processing circuitry, an anomaly recognition result of the image based on the extracted image feature, the reconstructed image feature, and the first recognition information,
wherein the discriminator is a machine learning model trained based on a composite image sample, the composite image sample being generated based on inserting an anomaly into an original image sample that has no anomaly.

2. The method according to claim 1, wherein the determining the anomaly recognition result of the image comprises:
determining second recognition information based on the difference information between the extracted image feature and the reconstructed image feature, the second recognition information including second information elements, each one of the second information elements indicating a second probability of a respective pixel of the image having an anomaly;
determining segmentation information in the anomaly recognition result based on the first recognition information and the second recognition information, the segmentation information including third information elements, each one of the third information elements indicating a third probability a respective pixel of the image having an anomaly; and
determining the anomaly recognition result based on the segmentation information.

3. The method according to claim 2, wherein
a dimension of the difference information between the extracted image feature and the reconstructed image feature is less than a quantity of the pixels of the image; and
the determining the second recognition information includes:
obtaining an L2 norm of the difference information between the extracted image feature and the reconstructed image feature; and
upsampling the L2 norm to obtain the second recognition information.

4. The method according to claim 2, wherein the determining segmentation information comprises:
obtaining the segmentation information based on weighted summation or weighted averaging of the first recognition information and the second recognition information.

5. The method according to claim 2, further comprising:
determining an image classification result in the anomaly recognition result based on the segmentation information, the image classification result indicating a probability that the image is an anomalous image.

6. The method according to claim 5, wherein the determining the image classification result comprises:
obtaining the image classification result based on a maximum value or a standard deviation of the third information elements in the segmentation information.

7. The method according to claim 1, wherein
the extracting the image feature of the image includes:
inputting the image into a feature extractor in an image anomaly detection model, to obtain the extracted image feature outputted by the feature extractor,
the obtaining the reconstructed image feature includes:
inputting the extracted image feature into an encoder-decoder network in the image anomaly detection model, to obtain the reconstructed image feature outputted by the encoder-decoder network, a dimension of the reconstructed image feature being same as a dimension of the extracted image feature, and
the obtaining the first recognition information includes:
inputting the difference information between the extracted image feature and the reconstructed image feature into the discriminator in the image anomaly detection model, to obtain the first recognition information outputted by the discriminator.

8. The method according to claim 7, further comprising:
obtaining a first image sample having no anomaly;
obtaining first mask information based on the first image sample, the first mask information indicating a pixel having no anomaly in the first image sample;
obtaining a second image sample, the second image sample being generated based on the first image sample and second mask information, and the second mask information indicating a pixel that has an anomaly based on modifying a corresponding pixel in the first image sample;
inputting the first image sample into the feature extractor, to obtain a first extracted image feature sample outputted by the feature extractor;
inputting the first extracted image feature sample into the encoder-decoder network, to obtain a first reconstructed image feature sample outputted by the encoder-decoder network;
inputting first sample difference information between the first reconstructed image feature sample and the first extracted image feature sample into the discriminator, to obtain a first recognition information sample outputted by the discriminator;
inputting the second image sample into the feature extractor, to obtain a second extracted image feature sample outputted by the feature extractor;
inputting the second extracted image feature sample into the encoder-decoder network, to obtain a second reconstructed image feature sample outputted by the encoder-decoder network;
inputting second sample difference information between the second reconstructed image feature sample and the second extracted image feature sample into the discriminator, to obtain a second recognition information sample outputted by the discriminator;
determining a loss function evaluation result based on the first extracted image feature sample, the first reconstructed image feature sample, the first recognition information sample, the second extracted image feature sample, the second reconstructed image feature sample, and the second recognition information sample; and
updating a parameter of the image anomaly detection model based on the loss function evaluation result.

9. The method according to claim 8, wherein the determining the loss function evaluation result comprises:
determining a first loss function value based on difference information between the first extracted image feature sample and the first reconstructed image feature sample;
determining a second loss function value based on difference information between the first recognition information sample and the first mask information;
determining a third loss function value based on difference information between the second extracted image feature sample and the second reconstructed image feature sample; and
determining a fourth loss function value based on difference information between the second recognition information sample and the second mask information.

10. An image processing apparatus, comprising:
processing circuitry configured to:
extract an image feature of an image;
obtain a reconstructed image feature based on encoding the extracted image feature and decoding the encoded image feature;
obtain, through a discriminator, first recognition information based on difference information between the extracted image feature and the reconstructed image feature, the first recognition information including first information elements, each one of the first information elements indicating a first probability of a respective pixel of the image having an anomaly; and
determine an anomaly recognition result of the image based on the extracted image feature, the reconstructed image feature, and the first recognition information,
wherein the discriminator is a machine learning model trained based on a composite image sample, the composite image sample being generated based on inserting an anomaly into an original image sample that has no anomaly.

11. The apparatus according to claim 10, wherein the processing circuitry is configured to:
determine second recognition information based on the difference between the extracted image feature and the reconstructed image feature, the second recognition information including second information elements, each one of the second information elements indicating a second probability of a respective pixel of the image having an anomaly;
determine segmentation information in the anomaly recognition result based on the first recognition information and the second recognition information, the segmentation information including third information elements, each one of the third information elements indicating a third probability a respective pixel of the image having an anomaly; and
determine the anomaly recognition result based on the segmentation information.

12. The apparatus according to claim 11, wherein
a dimension of the difference between the extracted image feature and the reconstructed image feature is less than a quantity of the pixels of the image; and
the processing circuitry is configured to:
obtain an L2 norm of the difference between the extracted image feature and the reconstructed image feature; and
upsample the L2 norm to obtain the second recognition information.

13. The apparatus according to claim 11, wherein the processing circuitry is configured to:
obtain the segmentation information based on weighted summation or weighted averaging of the first recognition information and the second recognition information.

14. The apparatus according to claim 11, wherein the processing circuitry is configured to:
determine an image classification result in the anomaly recognition result based on the segmentation information, the image classification result indicating a probability that the image is an anomalous image.

15. The apparatus according to claim 14, wherein the processing circuitry is configured to:
obtain the image classification result based on a maximum value or a standard deviation of the third information elements in the segmentation information.

16. The apparatus according to claim 10, wherein the processing circuitry is configured to:
input the image into a feature extractor in an image anomaly detection model, to obtain the extracted image feature outputted by the feature extractor;
input the extracted image feature into an encoder-decoder network in the image anomaly detection model, to obtain the reconstructed image feature outputted by the encoder-decoder network, a dimension of the reconstructed image feature being same as a dimension of the extracted image feature; and
input the difference between the extracted image feature and the reconstructed image feature into the discriminator in the image anomaly detection model, to obtain the first recognition information outputted by the discriminator.

17. The apparatus according to claim 16, wherein the processing circuitry is configured to:
obtain a first image sample having no anomaly;
obtain first mask information based on the first image sample, the first mask information indicating a pixel having no anomaly in the first image sample;
obtain a second image sample, the second image sample being generated based on the first image sample and second mask information, and the second mask information indicating a pixel that has an anomaly based on modifying a corresponding pixel in the first image sample;
input the first image sample into the feature extractor, to obtain a first extracted image feature sample outputted by the feature extractor;
input the first extracted image feature sample into the encoder-decoder network, to obtain a first reconstructed image feature sample outputted by the encoder-decoder network;
input a first sample difference between the first reconstructed image feature sample and the first extracted image feature sample into the discriminator, to obtain a first recognition information sample outputted by the discriminator;
input the second image sample into the feature extractor, to obtain a second extracted image feature sample outputted by the feature extractor;
input the second extracted image feature sample into the encoder-decoder network, to obtain a second reconstructed image feature sample outputted by the encoder-decoder network;
input a second sample difference between the second reconstructed image feature sample and the second extracted image feature sample into the discriminator, to obtain a second recognition information sample outputted by the discriminator;
determine a loss function evaluation result based on the first extracted image feature sample, the first reconstructed image feature sample, the first recognition information sample, the second extracted image feature sample, the second reconstructed image feature sample, and the second recognition information sample; and
update a parameter of the image anomaly detection model based on the loss function evaluation result.

18. The apparatus according to claim 17, wherein the processing circuitry is configured to:
determine a first loss function value based on difference information between the first extracted image feature sample and the first reconstructed image feature sample;
determine a second loss function value based on difference information between the first recognition information sample and the first mask information;
determine a third loss function value based on difference information between the second extracted image feature sample and the second reconstructed image feature sample; and
determine a fourth loss function value based on difference information between the second recognition information sample and the second mask information.

19. An image processing method, the method comprising:
obtaining a first image sample having no anomaly;
obtaining first mask information based on the first image sample, the first mask information indicating a pixel having no anomaly in the first image sample;
obtaining a second image sample, the second image sample being generated based on the first image sample and second mask information, and the second mask information indicating a pixel that has an anomaly based on modifying a corresponding pixel in the first image sample;
inputting the first image sample into a feature extractor in an image anomaly detection model, to obtain a first extracted image feature sample outputted by the feature extractor;
inputting the first extracted image feature sample into an encoder-decoder network in the image anomaly detection model, to obtain a first reconstructed image feature sample outputted by the encoder-decoder network;
inputting first sample difference information between the first reconstructed image feature sample and the first extracted image feature sample into a discriminator in the image anomaly detection model, to obtain a first recognition information sample outputted by the discriminator;
inputting the second image sample into the feature extractor, to obtain a second extracted image feature sample outputted by the feature extractor;
inputting the second extracted image feature sample into the encoder-decoder network, to obtain a second reconstructed image feature sample outputted by the encoder-decoder network;
inputting second sample difference information between the second reconstructed image feature sample and the second extracted image feature sample into the discriminator, to obtain a second recognition information sample outputted by the discriminator;
determining, by processing circuitry, a loss function evaluation result based on the first extracted image feature sample, the first reconstructed image feature sample, the first recognition information sample, the second extracted image feature sample, the second reconstructed image feature sample, and the second recognition information sample;
updating, by the processing circuitry, a parameter of the image anomaly detection model based on the loss function evaluation result; and
determining an anomaly recognition result of a target image through the image anomaly detection model.

20. The method according to claim 19, wherein the determining the loss function evaluation result comprises:
determining a first loss function value based on difference information between the first extracted image feature sample and the first reconstructed image feature sample;
determining a second loss function value based on difference information between the first recognition information sample and the first mask information;
determining a third loss function value based on difference information between the second extracted image feature sample and the second reconstructed image feature sample; and
determining a fourth loss function value based on difference information between the second recognition information sample and the second mask information.
